(19) United States
(12) Patent Application Publication
(10) Pub. No.: US 2024/0130362 A1
(43) Pub. Date: Apr. 25, 2024

(54) COMPOSITE SOLUTION FOR ENHANCING INDUCED DISEASE RESISTANCE OF LENTINAN (LNT) TO PLANT, PREPARATION METHOD OF COMPOSITE SOLUTION, AND METHOD FOR ENHANCING INDUCED DISEASE RESISTANCE OF LNT TO PLANT

(71) Applicants: KUNMING CO YUNNAN TOBACCO CO, Kunming (CN); China Agricultural University, Beijing (CN)

(72) Inventors: Yonghui XIE, Kunming (CN); Dekai NING, Kunming (CN); Zhijiang WANG, Kunming (CN); Shuo YAN, Beijing (CN); Wei LI, Kunming (CN); Jie SHEN, Beijing (CN); Zhengling LIU, Kunming (CN); Qinhong JIANG, Beijing (CN); Youguo ZHAN, Kunming (CN); Yuanshen WANG, Kunming (CN); Cun GUO, Kunming (CN); Sihao WU, Kunming (CN); Haohao LI, Kunming (CN)

(73) Assignees: KUNMING CO YUNNAN TOBACCO CO, Kunming (CN); China Agricultural University, Beijing (CN)

(21) Appl. No.: 18/449,727

(22) Filed: Aug. 15, 2023

(30) Foreign Application Priority Data
Oct. 8, 2022 (CN) 202211223837.3

(51) Int. Cl. A01N 25/22; A01N 43/16

(52) U.S. Cl. CPC A01N 25/22; A01N 43/16; A01P 1/00

(57) ABSTRACT

A composite solution for enhancing induced disease resistance of lentinan (LNT) to a plant, a preparation method of the composite solution, and a method for enhancing induced disease resistance of LNT to a plant are provided. The composite solution for enhancing induced disease resistance of LNT to a plant includes: an LNT-containing solution and an SPc-containing solution, where SPc is a dendritic macromolecule functionalized by an amino functional group, and has a structural formula shown in formula I, where n=1 to 100. An LNT/SPc complex is produced in the composite solution. SPc spontaneously combines with LNT through hydrogen bonding, such that an agglomerate structure formed by LNT in an aqueous solution is broken and reduced to a nano-scale particle size, and a spherical particle is produced, which can significantly reduce a contact angle of the LNT aqueous solution, and promote the distribution and diffusion of LNT.

### CROSS REFERENCE TO THE RELATED APPLICATIONS

This application is based upon and claims priority to Chinese Patent Application No. 202211223837.3, filed on Oct. 8, 2022, the entire contents of which are incorporated herein by reference.

### SEQUENCE LISTING

The instant application contains a Sequence Listing which has been submitted in XML format via EFS-Web and is hereby incorporated by reference in its entirety. Said XML, copy is named GBDHHY011-PKG Sequence Listing.xml, created on 08/01/2023, and is 6,102 bytes in size.

### TECHNICAL FIELD

The present application relates to the technical field of pesticides, and in particular, relates to a composite solution for enhancing induced disease resistance of lentinan (LNT) to a plant, a preparation method of the composite solution, and a method for field control of a plant virus.

### BACKGROUND

In recent years, the zero growth in pesticide consumption in China has steadily advanced and the utilization of pesticides in China has gradually increased. However, chemical pesticide consumption per unit area in China is 2 times or higher than the average consumption of agriculturally advanced countries and the utilization of pesticides in China is 11% to 20% lower than the utilization of pesticides in developed countries in Europe and America. How to further improve the utilization of pesticides and reduce the consumption of traditional chemical pesticides has become a common topic for plant protection workers in China. The development of nano-pesticides is one of the effective ways to reduce the consumption of pesticides and control the harm of pesticides. A nanocarrier additive can greatly improve the physical and chemical properties of a pesticide and realize the efficient delivery of a pesticide molecule to enhance the efficacy of the pesticide and reduce the consumption of the pesticide, which has promising application prospects.

The applicants develop a series of pharmaceutical nanocarriers in an early stage. For example, CN201910618636.5 discloses a dendritic macromolecule and a nanocarrier functionalized with an amino functional group and the nanocarrier can bind to a botanical pesticide molecule through hydrogen bonding and a hydrophobic action, which can overcome the problem that existing botanical pesticides have poor toxicity and durability. The botanical pesticide molecule includes matrine, pyrethrins, and D-limonene. However, it does not pay attention to LNT and how this nanocarrier can enhance the induced disease resistance of LNT to a plant. Nano-scale pesticide loading can be achieved through intermolecular interaction to greatly improve the delivery efficiency of a pesticide into living cells, and preliminary research results have shown that the nano-scale pesticide loading can improve the control efficiency, reduce the pesticide consumption, and expand the control spectrum, which provides a new technical way for the effective utilization of pesticides.

LNT is a polysaccharide extracted and purified from a fruiting body of Lentinus edodes, and a basic structure of LNT is a polymer glucan including 5 β(1→3) glucose straight chains each with 2 β-(1→6) side chains. Existing LNT can be used to control plant viruses in the field of pesticides. For example, CN200910248521.8 discloses that a complex of LNT and Jinggangmycin (JGM) can be used as a novel biological pesticide and also discloses that LNT can be used alone to control the rice stripe disease.

In addition, in the existing literature “Research on Effect of Lentinan (LNT) for Inducing Resistance of Cucumber to Downy Mildew and Effect of Mixture of LNT with Fluopimomide for Inducing Resistance of Cucumber to Downy Mildew” [D]. Li Pengpeng, Shandong Agricultural University, 2014, it is disclosed that LNT can be used to induce the resistance of cucumber to downy mildew. However, the ability of the existing LNT applied in the field to induce the disease resistance of a crop is not strong and not durable. If the pesticide is not applied in advance for prevention or if the pesticide is not applied in time after onset, a disease is difficult to control.

However, in the prior art, there is a lack of reagents and induction methods that can effectively induce tobacco to produce resistance to tobacco virus disease (an important tobacco disease).

### SUMMARY

The present application provides a composite solution for enhancing induced disease resistance of LNT to a plant, a preparation method of the composite solution, and a method for field control of a plant virus. The present application is intended to solve the technical problem in the prior art that the induced disease resistance of LNT to a plant is poor and the rapid and effective control of a virus-infected plant cannot be achieved by spraying existing LNT.

In a first aspect, the present application provides a composite solution for enhancing induced disease resistance of LNT to a plant, including: an LNT-containing solution and an SPc-containing solution, where SPc is a dendritic macromolecule functionalized by an amino functional group, and has a structural formula shown in formula I, where n=1 to 100:

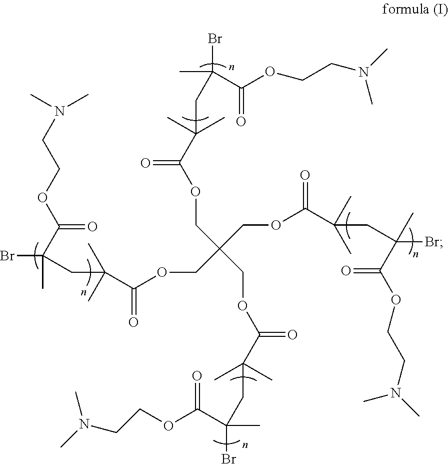

and

the induced disease resistance of a plant is at least one selected from the group consisting of induced viral resistance of a tobacco plant, induced viral resistance of a tomato plant, induced viral resistance of a potato plant, and induced viral resistance of a cucumber plant.

Preferably, the induced disease resistance of a plant is at least one selected from the group consisting of induced tobacco mosaic virus (TMV) resistance of a tobacco plant, induced tomato chlorosis virus (ToCV) resistance of a tomato plant, induced potato virus Y (PVY) resistance of a potato plant, and induced cucumber mosaic virus (CMV) resistance of a cucumber plant.

A specific structure of SPc can refer to CN201910618636.5.

The composite solution obtained by mixing the LNT-containing solution with the SPc-containing solution can significantly change the expression of 555 genes, effectively increase a number of genes that affect the expression of TMV in a tobacco plant by LNT. Compared with the treatment by the LNT alone, the expression of genes enhancing disease resistance in a tobacco plant is significantly improved in the treatment by the composite solution; compared with the treatment by the LNT alone, an expression level of TMV is decreased by 33.84% in the treatment by the LNT/SPc complex; in the early pesticide-spray group, an expression level of TMV in the treatment by the LNT/SPc complex is decreased by 26.82% compared with the treatment by the LNT alone; and in the first TMV-inoculation and then pesticide-spray group and in the early pesticide-spray group, an expression level of TMV is decreased by 24.50% in the treatment by the LNT/SPc complex compared with the treatment by the LNT alone, indicating a significant effect.

The composite solution can also be used to induce viral resistance of the above plants and exhibits a prominent effect.

The composite solution is prepared by mixing the LNT-containing solution with the SPc-containing solution.

Preferably, a mass ratio of the LNT-containing solution to the SPc-containing solution is 1:(1−4).

Preferably, the LNT-containing solution has a concentration of 1 mg/mL to 4 mg/mL and the SPc-containing solution has a concentration of 1 mg/mL to 16 mg/mL. The above two solutions can be mixed in the above ratio to obtain the composite solution with the above effects.

Preferably, a concentration of LNT in the composite solution is 20 mg/L to 1,000 mg/L.

Preferably, in the composite solution, a binding coefficient Ka (M₋₁) of the SPc to the LNT is 5.099×10⁵; a Gibbs free energy ΔG is −38.29 kJ/mol; and a non-covalent molecular interaction occurs between the SPc and the LNT, and mainly includes hydrogen bonding.

Preferably, in the composite solution, the SPc and the LNT form a spherical LNT/SPc complex of a uniform size, the spherical LNT/SPc complex has an average particle size of 141.79±1.38 nm, and a contact angle of the spherical LNT/SPc complex is reduced to 82.67°.

The above characteristics all prove that the binding of SPc to LNT in the composite solution is reliable and the reduction in the contact angle is conducive to the leveling of the composite solution on a surface of a plant to form a film and promote the penetration of LNT into the plant.

In a second aspect, the present application provides a preparation method of the composite solution described above, including the following steps: dissolving the LNT, mixing a resulting LNT-containing solution with the SPc-containing solution, subjecting a resulting mixed solution to an ultrasonic treatment for complete dissolution, and filtering to obtain the composite solution.

Preferably, the ultrasonic treatment is conducted for 2 minutes to 3 minutes and the filtering is conducted with a 450 nm filter membrane.

The preparation method can lead to a composite solution in which an LNT/SPc complex is reliably produced to promote the penetration of LNT into a plant.

In a third aspect, the present application provides a method for enhancing induced disease resistance of LNT to a plant, including at least one selected from the group consisting of steps a to c:
a. dissolving each of LNT and SPc with a plant virus supernatant to obtain an LNT-containing solution and an SPc-containing solution, mixing the LNT-containing solution with the SPc-containing solution to obtain the composite solution described above, and inoculating the composite solution into a plant to be induced;
b. dissolving each of LNT and SPc with water as a solvent to obtain an LNT-containing solution and an SPc-containing solution, mixing the LNT-containing solution with the SPc-containing solution to obtain the composite solution described above, and inoculating the composite solution into a plant to be induced; and
c. inoculating a plant virus supernatant into a plant to be induced, and 6 h to 48 h later, spraying the plant to be induced with the composite solution described above,
where the composite solution is obtained by dissolving each of LNT and SPc with water as a solvent to obtain an LNT-containing solution and a SPc-containing solution and mixing the LNT-containing solution with the SPc-containing solution.

Preferably, a plant virus is at least one selected from the group consisting of TMV, ToCV, PVY, and CMV.

After being treated by the above method, the plant to be induced can be induced to develop resistance for the virus, with an improved induction effect.

In a fourth aspect, the present application provides a method for field control of a plant virus, including step a orb:
a. spraying the composite solution on a surface of a plant infected with a virus to be controlled; and
b. spraying the composite solution on a surface of a plant uninfected with a virus.

Preferably, a plant virus is at least one selected from the group consisting of TMV, ToCV, PVY, and CMV.

The application of the composite solution can achieve the effective control for tobacco leaves that have been infected with a virus. The composite solution can replace pesticides and reduce the consumption of pesticides, thereby achieving the effect of environmental protection. Possible beneficial effects of the present application:
1) In the method and agent for enhancing induced disease resistance of LNT to a plant provided in the present application, tobacco virus disease (an important tobacco disease) is selected as a control target, and a star polycation (SPc) nanocarrier is used to load LNT to reduce a particle size of LNT in an aqueous solution, which further enhances the induced disease resistance of a tobacco plant to improve a control effect for tobacco virus disease, and further improves the green control technology system for pests in the tobacco field to create a green and sustainable farmland ecological environment.
2) In the method and agent for enhancing induced disease resistance of LNT to a plant provided in the present application, a composite solution is prepared to obtain an LNT/SPc complex, and the LNT/SPc complex can induce the resistance of a plant to a virus and can also achieve a control effect for a virus-infected plant. Therefore, the composite solution can replace pesticides and reduce the consumption of pesticides. The LNT is nanosized to greatly improve the biological activity of LNT and increase the medicinal values of LNT. It is highlighted that, after LNT is nanosized, the original agglomerate structure of LNT is changed, such that resulting LNT can further significantly enhance the immune response and antiviral ability of a plant and effectively control the occurrence and transmission of a virus in the field.

### BRIEF DESCRIPTION OF THE DRAWINGS

FIG. 1 shows isothermal titration calorimetry (ITC) titration results of an SPc/LNT complex obtained in an example of the present application;

FIG. 2 shows a transmission electron microscopy (TEM) image of LNT used in Example 1 of the present application;

FIG. 3 shows a TEM image of an SPc/LNT complex obtained in an example of the present application;

FIG. 4 shows a detection intensity-particle size relationship curve of an SPc/LNT complex obtained in an example of the present application;

FIG. 5 shows the comparison of contact angle results of water, SPc, LNT, and an SPc/LNT complex obtained in an example of the present application;

FIG. 6 is a histogram illustrating contact angle test results of water, SPc, LNT, and an SPc/LNT complex obtained in an example of the present application;

FIG. 7 is a volcano plot illustrating transcriptome analysis results of treatment by an SPc/LNT complex obtained in an example of the present application and treatment by LNT alone, where the left panel shows down-regulated 214 points, the middle panel shows normal points, and the right panel shows up-regulated points;

FIG. 8 is a scatter plot illustrating differential gene numbers among transcriptome analysis results of treatment by an SPc/LNT complex obtained in an example of the present application and treatment by LNT alone;

FIG. 9 is an analysis chart illustrating resistance induction-associated genes among transcriptome analysis results of treatment by an SPc/LNT complex obtained in an example of the present application and treatment by LNT alone;

FIG. 10 shows results obtained after a tobacco resistance induction treatment (1) in the indoor bioactivity determination of the LNT/SPc complex in an inhibition effect diagram of an SPc/LNT complex obtained in an example of the present application on the expression of TMV;

FIG. 11 shows results obtained after a tobacco resistance induction treatment (2) in the indoor bioactivity determination of the LNT/SPc complex in an inhibition effect diagram of an SPc/LNT complex obtained in an example of the present application on the expression of TMV;

FIG. 12 shows results obtained after a tobacco resistance induction treatment (3) in the indoor bioactivity determination of the LNT/SPc complex in an inhibition effect diagram of an SPc/LNT complex obtained in an example of the present application on the expression of TMV;

FIG. 13 is a picture illustrating a TMV field control effect of treatment with clean water alone for tobacco leaves in an example of the present application;

FIG. 14 is a picture illustrating a TMV field control effect of treatment with SPc alone for tobacco leaves in an example of the present application;

FIG. 15 is a picture illustrating a TMV field control effect of treatment with LNT alone for tobacco leaves in an example of the present application;

FIG. 16 is a picture illustrating a TMV field control effect of treatment with an SPc/LNT complex obtained in an example of the present application alone for tobacco leaves; and

FIG. 17 is a histogram illustrating TMV field control results of the treatment with clean water alone, treatment with SPc alone, and treatment with LNT alone in examples of the present application and the treatment with a SPc/LNT complex obtained in an example of the present application.

### DETAILED DESCRIPTION OF THE EMBODIMENTS

In order to make the objectives, technical solutions, and advantages of the embodiments of the present disclosure clearer, the technical solutions in the embodiments of the present disclosure will be clearly and completely described below in conjunction with the accompanying drawings in the embodiments of the present disclosure. Obviously, the described embodiments are some, rather than all of the embodiments of the present disclosure.

Therefore, the detailed description of the embodiments of the present disclosure in the accompanying drawings is not intended to limit the protection scope of the present disclosure, but merely represent the selected embodiments of the present disclosure. On the basis of the embodiments of the present disclosure, all other embodiments obtained by a person of ordinary skill in the art without making creative efforts shall fall within the protection scope of the present disclosure.

The technical means that are not detailed in the present application and are not intended to solve the technical problems of the present application are set in accordance with the common knowledge in the prior art and can be realized by a variety of common knowledge setting modes.

### EXAMPLES

Unless otherwise specified, the materials and instruments used in the following examples are commercially available.

### Example 1

A composite solution was prepared according to the following steps:

20 mg of LNT was accurately weighed and dissolved in 5 mL of ultrapure water (UPW) to obtain a 4 mg/mL stock solution, and the stock solution was mixed with 10 mg/mL SPc to obtain an LNT/SPc complex solution in which a mass ratio of LNT to SPc was 1:1 and a concentration of LNT was 0.5 mg/mL; and the LNT/SPc complex solution was subjected to an ultrasonic treatment in an ultrasonic cleaner for 2 minutes to 3 minutes to allow complete dissolution, and then filtered through a 450 nm filter membrane to obtain the composite solution.

### Example 2 Determination of Characteristics of an LNT/SPc Complex in the Composite Solution

1. Determination of a binding force of LNT to SPc in the LNT/SPc complex by ITC

A syringe for titration, a sample cell, and a standard cell each were washed 3 times with UPW, and then UPW was injected into the standard cell as a control. The sample cell was rinsed twice with a 0.031 mM LNT solution to be tested and then the LNT solution to be tested was added to the sample cell until a liquid level was flush with a metal edge of the sample cell. The syringe for titration was rinsed twice with a 0.31 mM SPc solution. After a sample solution was sucked into the syringe, a syringe piston was pulled out, the sample solution was allowed to flow toward a tail end of the syringe, and when the sample solution was about to flow out of the tail end, the syringe piston was inserted and pushed to allow a small amount of the sample solution to flow out of a needle, thereby ensuring that there were no air bubbles in the syringe. Finally, 250 μL of a 0.31 mMSPc titration solution was loaded in the syringe for titration, the syringe was screwed onto a handle, the needle was wiped to ensure that there was no residual liquid, and then the handle was arranged in a calorimeter. Test conditions of an ITC instrument (TANANOITC) were set as follows: a detection temperature was 25° C., titration was conducted 25 times in total, and 10 μL of a sample was injected each time at an interval of 300 s. The titration data were processed with NanoAnalyze™ software and fitted with Independent model to finally obtain thermodynamic parameters such as Ka, ΔH, and ΔS.

Experimental results:

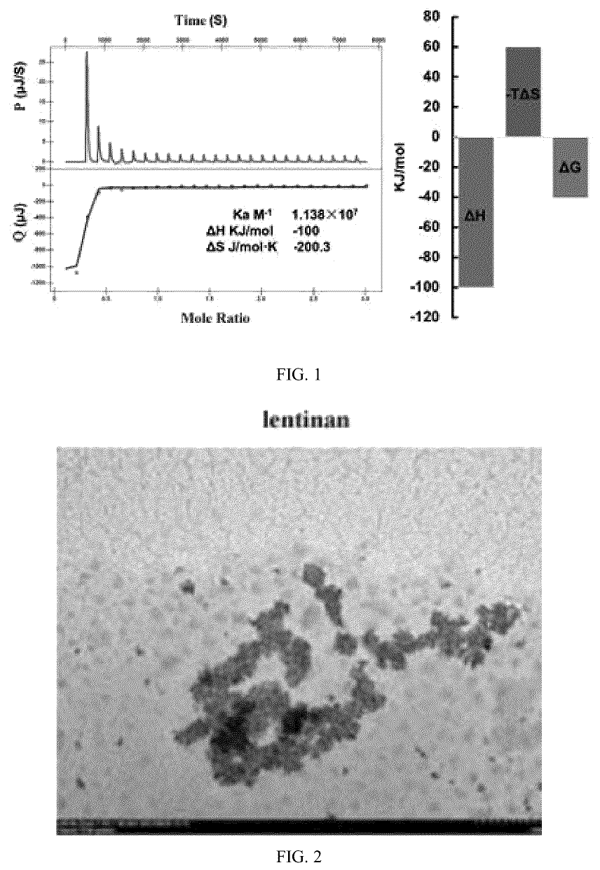

The ITC results showed (FIG. 1) that a binding coefficient Ka (M⁻¹) of the nanocarrier to LNT was 5.099×10⁵, indicating a strong interaction between the two. An entropy change ΔH was −56.91 kJ/mol, and an enthalpy change ΔS was −62.46 J/mol·K. According to ΔG=ΔH-TΔS, a Gibbs free energy ΔG of an interaction reaction between the two was calculated to be −38.29 kJ/mol, indicating that SPc could spontaneously bind to LNT. Based on the ΔH and ΔS of the reaction, it could be inferred that the non-covalent molecular interaction between SPc and LNT was mainly produced through hydrogen bonding.

2. Particle size and morphology observation of the LNT/SPc complex

20 mg of LNT was accurately weighed and dissolved in 5 mL of UPW to obtain a 4 mg/mL stock solution, and the stock solution was mixed with 10 mg/mL SPc to obtain an LNT/SPc complex solution in which a mass ratio of LNT to SPc was 1:1 and a concentration of LNT was 0.5 mg/mL; LNT of the same concentration was adopted as a control and the above sample solutions each were subjected to an ultrasonic treatment in an ultrasonic cleaner for 2 minutes to 3 minutes to allow complete dissolution, and then filtered through a 450 nm filter membrane.

Particle sizes of the LNT/SPc complex and the LNT were determined by a multi-angle particle size and high-sensitivity zeta potential analyzer under the following detection conditions: temperature: 25° C., solvent: water, number of detection times: 3, and stability time: 120 s.

In addition, 10 μL of the above sample solution was taken and placed on a copper mesh, then the copper mesh was air-dried, and the morphology was observed and photographed by a projection electron microscopy.

Experimental Results:

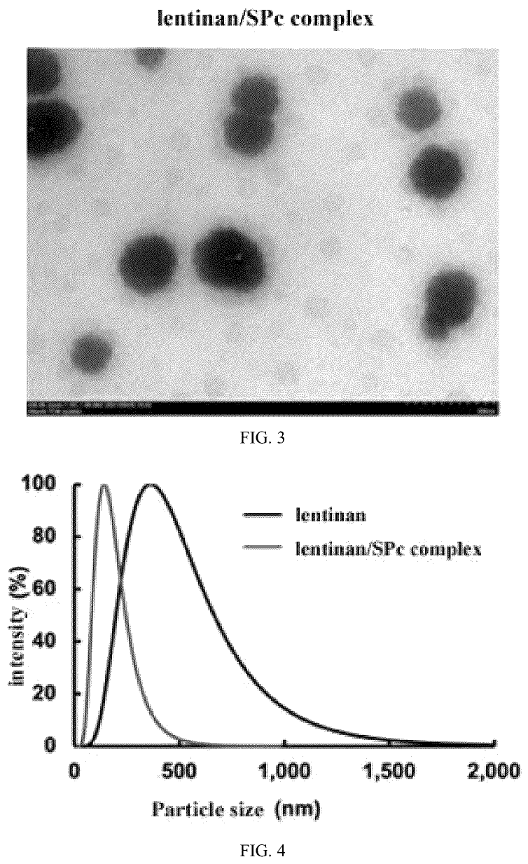

1) A particle size of LNT in the aqueous solution was 350 nm and a TEM result of LNT was shown in FIG. 2 and a particle size of the LNT/SPc complex was reduced to 142 nm (Table 1), and a TEM result of the LNT/SPc complex was shown in FIG. 3. The above particle size results were consistent with the TEM results, and the LNT/SPc complex was a spherical particle with a uniform size (FIG. 2). Particle size-detection intensity curves were shown in FIG. 4.

TABLE 1
Particle sizes of the LNT and the LNT/SPc complex

| | | Particle | Average particle |
|---|---|---|---|
| Solution | Sample No. | size (nm) | size (nm) |
| LNT | 1 | 341.50 | 350.08 ± 5.87 |
| | 2 | 347.43 | |
| | 3 | 361.30 | |
| LNT/SPc complex | 1 | 141.01 | 141.79 ± 1.38 |
| | 2 | 144.47 | |
| | 3 | 139.89 | |

t = 34.56, df = 4, P < 0.001

2) Detection of a contact angle of the LNT/SPc complex

A 0.5 mg/mL LNT/SPc complex was prepared with a mass ratio of LNT to SPc being 1:1, and LNT of the same concentration was adopted as a control. 10 μL of the sample solution was taken and added dropwise on ground glass with consistent smoothness and when a droplet was stabilized, an image was acquired, and a contact angle was calculated by an ellipsoid method.

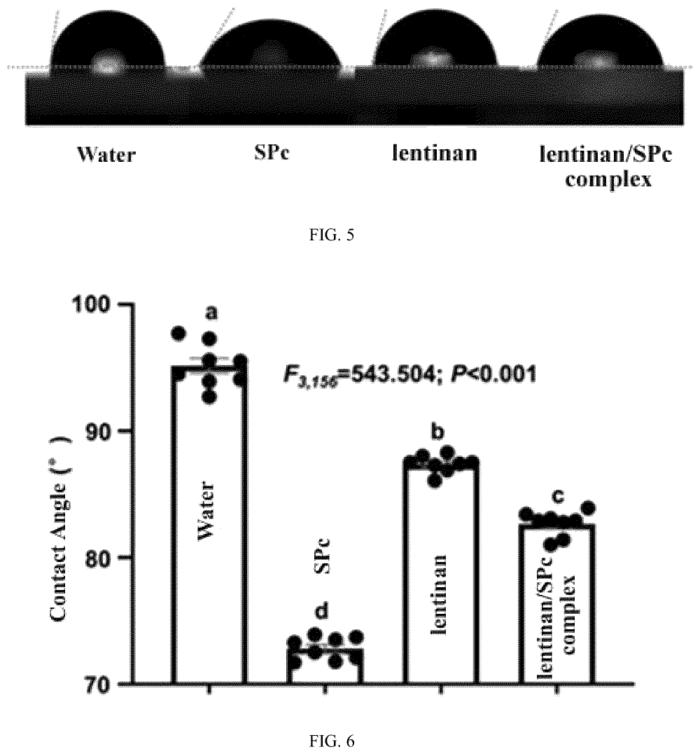

As shown in FIG. 5 to FIG. 6, a contact angle of LNT relative to a surface of the ground glass was 87.38°, and a contact angle of the LNT/SPc complex was reduced to 82.67°. Under an action of SPc, the contact angle of LNT relative to the ground glass was significantly reduced.

3. Analysis of a mechanism for LNT enhancing induced resistance of tobacco

Healthy tobacco plants were treated with clean water, a 20 mg/mL LNT, and a 20 mg/mL LNT/SPc complex, respectively. After the plants were treated for 24 h, total RNA was extracted from a tissue of each sample with the TRNzol formula described above (TIANGEN, China). Three independent samples were prepared for each treatment. A transcript library was constructed through the IlluminaHiSeq sequencing platform. A database KEGG was annotated with BLASTX. An expression level of each transcript was represented by an FPKM value. Deseq was used to analyze differentially expressed genes (DEGs) among different treatments, and the following screening conditions were adopted: fold change ≥2.0 and FDR <0.01.

Experimental Results:

1) Enhancement of the LNT/SPc complex for the expression of resistance genes in a plant.

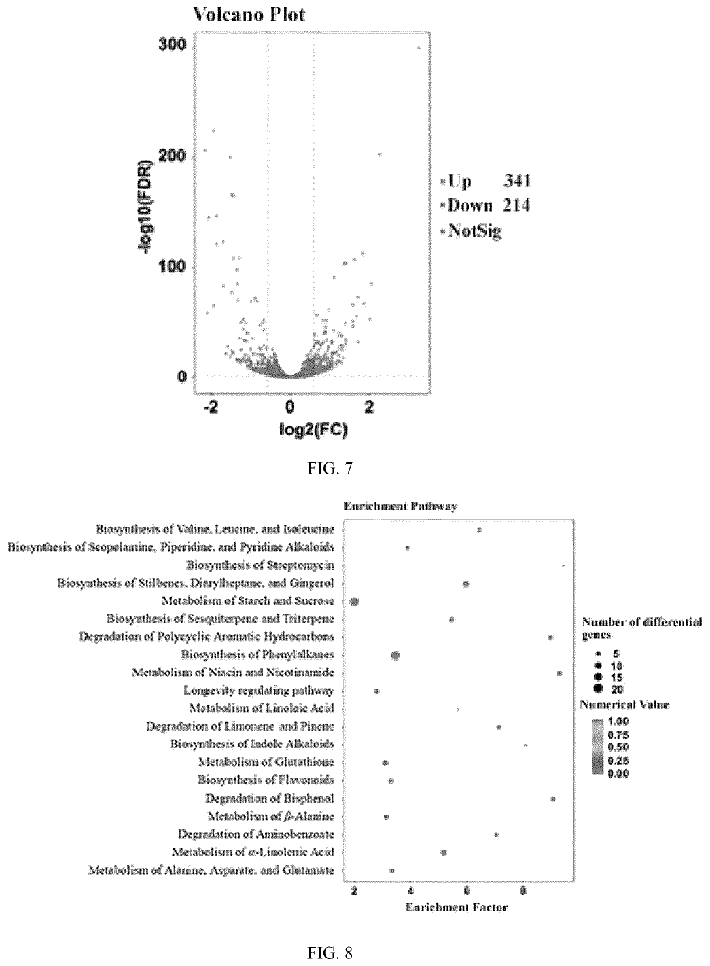

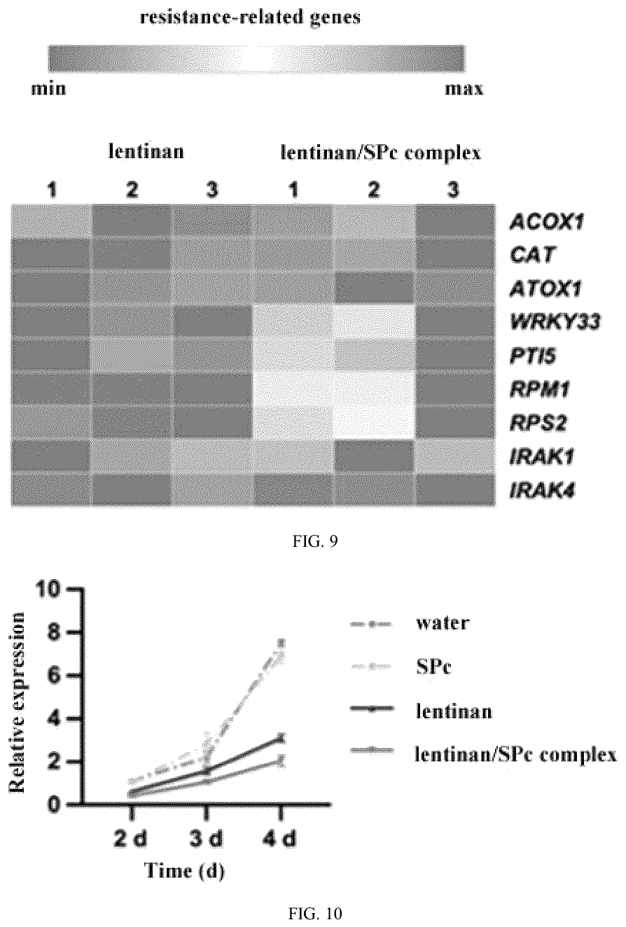

Results obtained were shown in FIG. 7 to FIG. 9 and compared with the treatment by LNT alone. The treatment by the LNT/SPc complex led to significant changes in expression of 555 genes, where 341 genes were up-regulated, and 214 genes were down-regulated (FIG. 7). The DEGs could be divided into various genetic pathways such as peroxisomes, plant-pathogen interactions, mineral absorption, and terpene biosynthesis (FIG. 8).

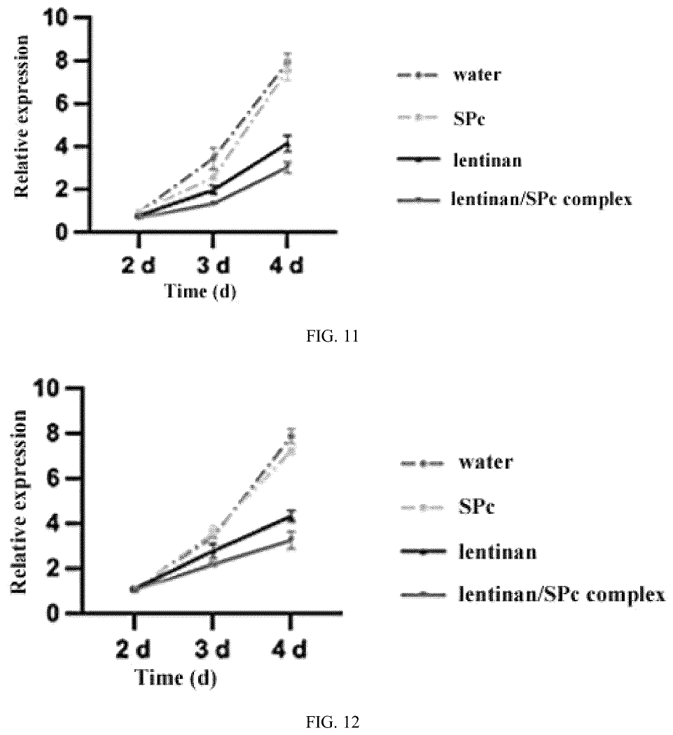

Results of the three different treatments were shown in FIG. 10 to FIG. 12. Compared with the treatment by LNT alone, the treatment by the LNT/SPc complex led to up-regulation of expression of various plant resistance induction-associated genes, indicating that SPc could enhance an induction effect of LNT for tobacco resistance (FIG. 12). For example, an increase in an expression level of an ACOX1 gene can promote the acquisition of electrons by 02 to produce H₂O₂ in large quantities, thereby inducing the expression of many other resistance genes in a plant; an increase in an expression level of a CAT gene can prevent cells from a toxic effect of H₂O₂; an increase in an expression level of an ATOX1 gene allows cytoplasmic copper to be combined and delivered to a copper ATPase protein, which plays an important role in cellular antioxidation defense; and the up-regulation of expression of a series of genes such as WRKY, PTI5, RPM1, RPS2, and IRAK can activate plant defense systems including hypersensitivity responses and plant innate immune responses, which can limit the growth and spread of pathogens and protect plants from pathogens.

4. Determination of indoor bioactivity of the LNT/SPc complex

Extraction of TMV: 0.1 g of tobacco leaves with obvious tobacco mosaic symptoms were collected and ground in liquid nitrogen, 1 mL of 0.01 M phosphate buffered saline (PBS) (pH 7.0) was added, and a resulting mixture was shaken, placed on ice for 5 minutes, and centrifuged at 4° C. and 5,000 rpm to obtain a supernatant, which was TMV.

The following three treatments were adopted to evaluate the enhancement of SPc for induced resistance of LNT to tobacco:

(1) LNT and SPc each were dissolved with a TMV supernatant to prepare a 20 mg/L SPc solution, a 20 mg/L LNT solution, and a 20 mg/L LNT/SPc complex solution, and these sample solutions were allowed to stand at room temperature for 30 minutes; and a TMV supernatant was adopted as a control. The above solutions were inoculated on the third and fourth leaves of 36 tobacco plants at a six-leaf stage.

(2) A 20 mg/L SPc solution, a 20 mg/L LNT solution, and a 20 mg/L LNT/SPc complex solution each were prepared and evenly sprayed on 36 tobacco plants at a six-leaf stage, and clean water was adopted as a control; and 24 h later, a TMV supernatant was inoculated on the third and fourth leaves of tobacco.

(3) A TMV supernatant was inoculated on the third and fourth leaves of tobacco, and 24 h later, clean water, a 20 mg/L SPc solution, a 20 mg/L LNT solution, and a 20 mg/L LNT/SPc complex solution each were evenly sprayed on the inoculated tobacco.

At 48 h, 72 h, and 96 h after inoculation, the third leaves of 4 tobacco plants in each treatment were collected and thoroughly ground in liquid nitrogen, and three replicates were prepared. Total RNA was extracted from a tissue lysate with a Tiangen RNA extraction kit. cDNA was acquired by a Takara reverse-transcription kit. With a CP protein gene sequence of TMV as a target gene, fluorescent quantitative polymerase chain reaction (FQ-PCR) primers GCGATTGTGACACCAAACCAGCG, as shown in SEQ ID NO: 1, and TCGGAAGCCGATGGACGCGA, as shown in SEQ ID NO: 2, were designed, and with a tobacco GAPDH gene as an internal reference gene, FQ-PCR primers TGCAGTGAACGACCCATTTA, as shown in SEQ ID NO: 3, and TGGATTCCACAACGAAATCA, as shown in SEQ ID NO: 4, were designed. FQ-PCR was conducted with ABIQuantStudio6 under the following reaction conditions: 94° C. for 10 minutes, 60° C. for 30 s, 40 cycles. A 2^{-ΔΔCT} method was used to calculate a relative expression level of a CP protein gene of TMV.

Experimental Results:

Indoor bioactivity of the LNT/SPc complex

After 4 d of treatment by each of the above three methods, total RNA was extracted from tobacco leaves, and a relative expression level of TMV was determined.

Results (as shown in FIG. 10 to FIG. 12):

A relative expression level of TMV in a plant can be first detected by fluorescence quantification. The higher the expression level, the higher the TMV content in the plant and the more serious the disease of the plant. The lower the expression level, the healthier the plant, reflecting a resistance induction effect of LNT for the plant.

A: The virus was incubated with the LNT/SPc complex and then inoculated. TMV was treated in vitro to determine whether the pesticide has a passivation effect for TMV in addition to the resistance induction effect.

B: The pesticide was first applied and then TMV was inoculated. In this treatment mode, a plant was allowed to develop resistance, and then the virus was inoculated, such as to evaluate a preventive effect of the pesticide for the viral disease and provide a basis for early application in the field to prevent the virus.

C: TMV was first inoculated and then the pesticide was applied to evaluate a control effect of the pesticide for the virus, which was a relatively common situation in the field.

In the TMV incubation in vitro and inoculation group, compared with the treatment by the LNT alone, an expression level of TMV was decreased by 33.84% in the treatment by the LNT/SPc complex; in the early pesticide-spray group, an expression level of TMV in the treatment by the LNT/SPc complex was decreased by 26.82% compared with the treatment by the LNT alone; and in the first TMV-inoculation and then pesticide-spray group and in the early pesticide-spray group, an expression level of TMV was decreased by 24.50% in the treatment by the LNT/SPc complex compared with the treatment by the LNT alone.

5. Determination of a field control effect of the LNT/SPc complex

A control test for a viral disease was conducted in a Yunnan tobacco field. A 10 mu tobacco field with single and uniform onset of a TMV disease was selected and randomly divided into small areas; four treatments were set with clean water control, a 20 mg/mL SPc solution, a 20 mg/mL LNT solution, and a 20 mg/mL LNT/SPc nanocarrier complex solution, respectively; and 7 d and 14 d after application, investigation was conducted according to a viral disease grading standard in the national standard “Grade and Investigation Method of Tobacco Diseases and Insect Pests (GB/T23222−2008)”, and a field control effect was statistically counted.

Experimental results: Field control effect of the LNT/SPc complex

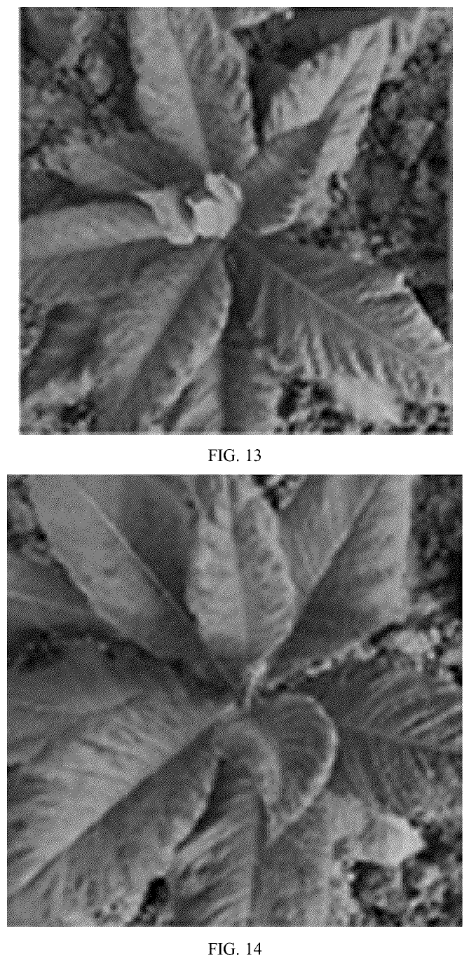

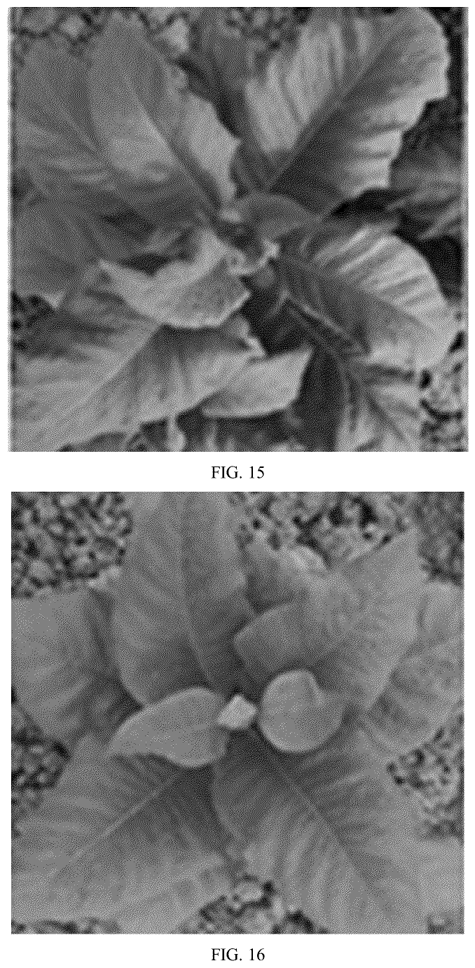

Results of the field application experiment were shown in FIG. 13 to FIG. 17. As shown in FIG. 13, FIG. 14, FIG. 15, and FIG. 16, the application of the composite solution provided by the present application could significantly improve a resistance induction effect of LNT for tobacco compared with the application of LNT alone or SPc alone.

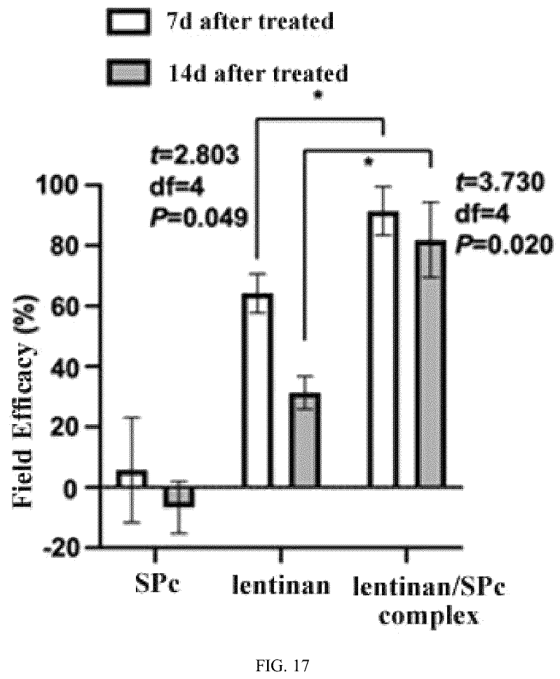

As shown in FIG. 17, a control effect reached 64.2% on day 7 after the treatment by LNT alone, but a control effect was only 31.3% on day 14 after the treatment by LNT alone; a control effect reached 91.5% on day 7 after the treatment by the LNT/SPc complex, and a control effect was still maintained at 81.9% on day 14 after the treatment by the LNT/SPc complex; and compared with the treatment by LNT alone, a control effect was increased by 27.3% and 50.6% on day 7 and day 14 after the treatment by the LNT/SPc complex, respectively.

### Example 3 Determination of a Field Control Effect of Induced Anti-ToCV Activity of a Tomato Plant

This example had similar experimental conditions to item 5 in Example 2, except that: a tomato plant uninfected with a virus was selected as a spray object; after each treatment group was sprayed with a corresponding treatment agent for 3 d, plants in each treatment group were inoculated with a ToCV-containing solution (OD₆₀₀: 0.5); and after the field management and planting was normally conducted for 7 d, disease conditions of plants in each treatment group were counted.

Experimental results: An incidence rate in tomato plants treated by the LNT/SPc composite solution was 10.6%; an incidence rate in tomato plants treated by the LNT alone was 43.7%; an incidence rate in tomato plants treated by 20 mg/mL SPc alone was 80.4%; and an incidence rate in tomato plants treated by the clean water control was 82.8%.

### Example 4 Determination of a Field Control Effect of Induced Anti-PVY Activity of a Potato Plant

This example had the same experimental conditions as item 5 in Example 2, except that the plant was a potato plant infected with PVY.

Experimental results: A control effect reached 79.8% on day 7 after the treatment by the LNT/SPc complex, and a control effect was still maintained at 63.7% on day 14 after the treatment by the LNT/SPc complex. Field control effect results of other control groups were similar to item 5 in Example 2 and were not repeated here.

### Example 5 Determination of a Field Control Effect of Induced Anti-CMV Activity of a Cucumber Plant

This example had the same experimental conditions as item 5 in Example 2, except that the plant was a cucumber plant infected with CMV.

Experimental results: A control effect reached 79.8% on day 7 after the treatment by the LNT/SPc complex, and a control effect was still maintained at 63.7% on day 14 after the treatment by the LNT/SPc complex. Field control effect results of other control groups were similar to item 5 in Example 2 and were not repeated here.

It can be seen from the results obtained in Examples 3 to 5 that the composite solution provided by the present application can also be used to induce the viral resistance of a tobacco plant, a tomato plant, a potato plants, and a cucumber plant. A field control effect can be realized by inducing the above plant to develop resistance.

### Example 6 LNT/SPc Composite Solution

This example was different from Example 1 in that: for the LNT/SPc composite solution in this example, an LNT-containing solution had a concentration of 1 mg/mL; an SPc-containing solution had a concentration of 1 mg/mL; a mass ratio of the LNT-containing solution to the SPc-containing solution was 1:1; and a concentration of LNT in the composite solution was 1,000 mg/L.

### Example 7 LNT/SPc Composite Solution

This example was different from Example 1 in that: for the LNT/SPc composite solution in this example, an LNT-containing solution had a concentration of 4 mg/mL; an SPc-containing solution had a concentration of 16 mg/mL; a mass ratio of the LNT-containing solution to the SPc-containing solution was 1:4; and a concentration of LNT in the composite solution was 20 mg/L.

### Example 8 LNT/SPc Composite Solution

This example was different from Example 1 in that: for the LNT/SPc composite solution in this example, an LNT-containing solution had a concentration of 3 mg/mL; an SPc-containing solution had a concentration of 10 mg/mL; a mass ratio of the LNT-containing solution to the SPc-containing solution was 1:3; and a concentration of LNT in the composite solution was 800 mg/L.

### Example 9 Method for Enhancing Induced Disease Resistance of LNT to a Plant

This example was different from the treatment in step 3 of item 4 in Example 2 in that: a plant virus supernatant was inoculated on a plant to be induced, and 6 h later, the composite solution was sprayed.

### Example 10 Method for Enhancing Induced Disease Resistance of LNT to a Plant

This example was different from the treatment in step 3 of item 4 in Example 2 in that: a plant virus supernatant was inoculated on a plant to be induced, and 48 h later, the composite solution was sprayed.

Experimental Conclusion:

In this study, an LNT nanodelivery system was successfully constructed.

(1) SPc can spontaneously combine with LNT through hydrogen bonding, such that an agglomerate structure formed by LNT in an aqueous solution is broken and reduced to a nano-scale particle size, and a spherical particle is produced, which can significantly reduce a contact angle of the LNT aqueous solution and promote the distribution and diffusion of LNT.

(2) Transcriptome sequencing analysis shows that the LNT/SPc complex can further activate peroxisomes, plant-pathogen interactions, mineral absorption, terpene biosynthesis, and other related gene pathways, and improve the expression of a series of plant resistance-associated genes.

(3) In laboratory and field environments, the treatment by the LNT/SPc complex can lead to better induced disease resistance of a plant than the treatment by LNT alone and can significantly improve a control effect for TMV. In summary, the LNT nanodelivery system constructed in this study can enhance the LNT-induced disease resistance of a plant and can be used for the efficient control of various tobacco diseases, which contributes to the national “pesticide and fertilizer double reduction” strategy and sustainable agricultural development.

Although the present disclosure is described in detail with reference to the above examples, those skilled in the art can still modify the technical solutions described in the above examples, or substitute some of the technical features of the examples. Any modifications, equivalent substitutions, improvements, and the like within the spirit and principle of the present disclosure should be included in the claimed scope of the present disclosure.

What is claimed is:

1. A composite solution for enhancing an induced disease resistance of lentinan (LNT) to a plant, comprising: an LNT-containing solution and an SPc-containing solution, wherein SPc is a dendritic macromolecule functionalized by an amino functional group and has a structural formula shown in formula I, wherein n=1 to 100: 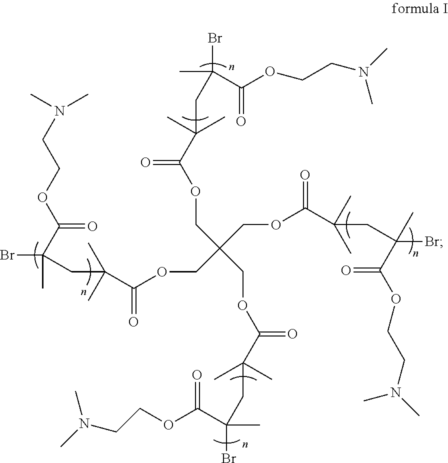
and
an induced disease resistance of the plant is at least one selected from the group consisting of an induced viral resistance of a tobacco plant, an induced viral resistance of a tomato plant, an induced viral resistance of a cucumber plant, and an induced viral resistance of a potato plant.

2. The composite solution according to claim 1, wherein the induced disease resistance of the plant is at least one selected from the group consisting of an induced tobacco mosaic virus (TMV) resistance of the tobacco plant, an induced tomato chlorosis virus (ToCV) resistance of the tomato plant, an induced potato virus Y (PVY) resistance of the potato plant, and an induced cucumber mosaic virus (CMV) resistance of the cucumber plant.

3. The composite solution according to claim 1, wherein a mass ratio of the LNT-containing solution to the SPc-containing solution is 1:(1−4); the LNT-containing solution has a concentration of 1 mg/mL to 4 mg/mL, the SPc-containing solution has a concentration of 1 mg/mL to 16 mg/mL, and a concentration of the LNT in the composite solution is 20 mg/L to 1,000 mg/L.

4. The composite solution according to claim 1, wherein in the composite solution, a binding coefficient Ka of the SPc to the LNT is 5.099×10⁵ M⁻¹; a Gibbs free energy ΔG is −38.29 kJ/mol; and a non-covalent molecular interaction occurs between the SPc and the LNT and comprises a hydrogen bonding.

5. The composite solution according to claim 1, wherein in the composite solution, the SPc and the LNT form a spherical LNT/SPc complex of a uniform size, the spherical LNT/SPc complex of the uniform size has an average particle size of 141.79±1.38 nm, and a contact angle of the spherical LNT/SPc complex of the uniform size is reduced to 82.67°.

6. A preparation method of the composite solution according to claim 1, comprising the following steps: dissolving the LNT to obtain the LNT-containing solution, mixing the LNT-containing solution with the SPc-containing solution, subjecting a resulting mixed solution to an ultrasonic treatment for a complete dissolution, and filtering a resulting mixture to obtain the composite solution.

7. The preparation method according to claim 6, wherein the ultrasonic treatment is conducted for 2 minutes to 3 minutes; and the filtering is conducted with a 450 nm filter membrane.

8. A method for enhancing the induced disease resistance of the LNT to the plant, comprising at least one selected from the group consisting of steps a to c:
a. dissolving each of the LNT and the SPc with a plant virus supernatant to obtain a first LNT-containing solution and a first SPc-containing solution, mixing the first LNT-containing solution with the first SPc-containing solution to obtain the composite solution according to claim 1, and inoculating the composite solution into the plant to be induced;
b. dissolving each of the LNT and the SPc with water as a solvent to obtain a second LNT-containing solution and a second SPc-containing solution, mixing the second LNT-containing solution with the second SPc-containing solution to obtain the composite solution according to claim 1, and inoculating the composite solution into the plant to be induced; and
c. inoculating the plant virus supernatant into the plant to be induced, and 6 h to 48 h later, spraying the plant to be induced with the composite solution according to claim 1, wherein a plant virus in the plant virus supernatant is at least one selected from the group consisting of TMV, ToCV, PVY, and CMV.

9. The preparation method according to claim 6, wherein in the composite solution, the induced disease resistance of the plant is at least one selected from the group consisting of an induced tobacco mosaic virus (TMV) resistance of the tobacco plant, an induced tomato chlorosis virus (ToCV) resistance of the tomato plant, an induced potato virus Y (PVY) resistance of the potato plant, and an induced cucumber mosaic virus (CMV) resistance of the cucumber plant.

10. The preparation method according to claim 6, wherein in the composite solution, a mass ratio of the LNT-containing solution to the SPc-containing solution is 1:(1−4); the LNT-containing solution has a concentration of 1 mg/mL to 4 mg/mL, the SPc-containing solution has a concentration of 1 mg/mL to 16 mg/mL, and a concentration of the LNT in the composite solution is 20 mg/L to 1,000 mg/L.

11. The preparation method according to claim 6, wherein in the composite solution, a binding coefficient Ka of the SPc to the LNT is 5.099×105 M₋₁; a Gibbs free energy ΔG is −38.29 kJ/mol; and a non-covalent molecular interaction occurs between the SPc and the LNT and comprises a hydrogen bonding.

12. The preparation method according to claim 6, wherein in the composite solution, the SPc and the LNT form a spherical LNT/SPc complex of a uniform size, the spherical LNT/SPc complex of the uniform size has an average particle size of 141.79±1.38 nm, and a contact angle of the spherical LNT/SPc complex of the uniform size is reduced to 82.67°.

13. The method according to claim 8, wherein in the composite solution, the induced disease resistance of the plant is at least one selected from the group consisting of an induced tobacco mosaic virus (TMV) resistance of the tobacco plant, an induced tomato chlorosis virus (ToCV) resistance of the tomato plant, an induced potato virus Y (PVY) resistance of the potato plant, and an induced cucumber mosaic virus (CMV) resistance of the cucumber plant.

14. The method according to claim 8, wherein in the composite solution, a mass ratio of the LNT-containing solution to the SPc-containing solution is 1:(1-4); the LNT-containing solution has a concentration of 1 mg/mL to 4 mg/mL, the SPc-containing solution has a concentration of 1 mg/mL to 16 mg/mL, and a concentration of the LNT in the composite solution is 20 mg/L to 1,000 mg/L.

15. The method according to claim 8, wherein in the composite solution, a binding coefficient Ka of the SPc to the LNT is 5.099×105 M⁻¹; a Gibbs free energy ΔG is −38.29 kJ/mol; and a non-covalent molecular interaction occurs between the SPc and the LNT and comprises a hydrogen bonding.

16. The method according to claim 8, wherein in the composite solution, the SPc and the LNT form a spherical LNT/SPc complex of a uniform size, the spherical LNT/SPc complex of the uniform size has an average particle size of 141.79±1.38 nm, and a contact angle of the spherical LNT/SPc complex of the uniform size is reduced to 82.67°.


SEQUENCE LISTING (4 sequences)

SEQ ID NO: 1 - DNA, 23 bp, synthetic construct
  misc_feature 1..23: note = The sequence is synthetized.
  source 1..23: mol_type = other DNA
gcgattgtgacaccaaaccagcg

SEQ ID NO: 2 - DNA, 20 bp, synthetic construct
  misc_feature 1..20: note = The sequence is synthetized.
  source 1..20: mol_type = other DNA
tcggaagccgatggacgcga

SEQ ID NO: 3 - DNA, 20 bp, synthetic construct
  misc_feature 1..20: note = The sequence is synthetized.
  source 1..20: mol_type = other DNA
tgcagtgaacgacccattta

SEQ ID NO: 4 - DNA, 20 bp, synthetic construct
  misc_feature 1..20: note = The sequence is synthetized.
  source 1..20: mol_type = other DNA
tggattccacaacgaaatca